(19) United States
(12) Patent Application Publication
(10) Pub. No.: US 2025/0146207 A1
(43) Pub. Date: May 8, 2025

(54) DISPENSING VARIABLE AMOUNTS OF FLUIDS

(71) Applicant: Delaware Capital Formation, Inc., Wilmington, DE (US)

(72) Inventors: Doug Menkedick, Guilford, IN (US); Randy Huff, Lynchburg, OH (US); Thomas M. Webster, Cleves, OH (US); Glen Shafer, Amelia, OH (US)

(21) Appl. No.: 18/934,883

(22) Filed: Nov. 1, 2024

Related U.S. Application Data
(60) Provisional application No. 63/595,447, filed on Nov. 2, 2023.

(51) Int. Cl. D06F 39/02; D06F 33/37; D06F 34/14; D06F 103/00; D06F 105/42; G05D 11/13

(52) U.S. Cl. CPC D06F 39/022; D06F 33/37; D06F 34/14; G05D 11/134; D06F 2103/00; D06F 2105/42

(57) ABSTRACT

Systems and methods for dispensing chemicals include an eductor having a diluent inlet, a chemical pickup port, a discharge port, and a venturi fluidly coupled between the diluent inlet and the discharge port. A diluent valve having an outlet is coupled to the diluent inlet. A chemical manifold includes a plurality of chemical inlets and a chemical outlet fluidly coupled to the chemical pickup port. A plurality of chemical valves are each coupled to one of the plurality of chemical inlets; and a controller is communicatively coupled to the diluent valve and the plurality of chemical valves and configured to operate the diluent valve and the chemical valves to dispense measured doses of individual chemicals through the chemical pickup port.

### CROSS-REFERENCE TO RELATED APPLICATION

This application claims the benefit under 35 U.S.C. § 119(e) of U.S. Patent Application No. 63/595,447, entitled “Dispensing Variable Amounts Of Fluids,” filed Nov. 2, 2023, which is incorporated herein by reference in its entirety.

### TECHNICAL FIELD

The present application relates to dispensing fluids.

### BACKGROUND

The dispensing of liquid chemical products into a receptacle or machine is a common requirement of many industries. For example, in a laundry environment it is often desirable to dispense one or more chemicals, such as detergents, bleaches, disinfectants, sanitizers, etc., for use in industrial laundry machines. Such chemicals may be dispensed directly into the machine and mixed with water or other diluent to form a solution. A number of dispensing systems have been developed for this purpose. For example, many systems use a chemical reservoir and a control valve to deliver chemical directly to the machine or receptacle. The control valve can be manual or configured as an electronic or pneumatic valve. In many applications, the system can include a way to meter the amount of chemical being dispensed into the machine or receptacle.

### SUMMARY

Chemical dispensing systems can use pulsing pumps (e.g., diaphragm pumps) to dispense a specified amount of a chemical. The output of the pump is measured using a flow meter; however, dosing resolution is linked to the size of the pump chamber. Pump sizes may be too large for accuracy when dosing small amounts and accuracy errors up to 90% can occur. Alternatively, smaller pumps can be used; however, the dispense time becomes prohibitive for large dosing amounts, for example, dosing 500 ml could take more time than the expected wash cycle in a laundry application.

This disclosure describes systems and methods for dispensing variable amounts of chemicals with dosing accuracy independent of pump size.

In an example implementation, a chemical dispensing system includes an eductor having a diluent inlet, a chemical pickup port, a discharge port, and a venturi fluidly coupled between the diluent inlet and the discharge port; a diluent valve having an outlet coupled to the diluent inlet; a chemical manifold comprising a plurality of chemical inlets and a chemical outlet fluidly coupled to the chemical pickup port; a plurality of chemical valves, each coupled to one of the plurality of chemical inlets; and a controller communicatively coupled to the diluent valve and the plurality of chemical valves and configured to operate the diluent valve and the chemical valves to dispense measured doses of individual chemicals through the chemical pickup port.

An aspect combinable with the example implementation further includes a flow meter fluidly coupled inline between the outlet of the chemical manifold and the chemical pickup port.

In another aspect combinable with any of the previous aspects, the flow meter includes a piston, and the flow meter is configured to measure a flow rate based on displacement of the piston.

In another aspect combinable with any of the previous aspects, the flow meter includes a capacitive detector, an infrared detector, an ultrasonic detector, or a hall effect detector configured to detect displacement of the piston.

In another aspect combinable with any of the previous aspects, the discharge port is fluidly coupled to one or more laundry machines.

In another aspect combinable with any of the previous aspects, an inlet of at least one of the chemical valves is fluidly coupled to a chemical reservoir.

In another aspect combinable with any of the previous aspects, the controller includes memory storing calibration data.

In another aspect combinable with any of the previous aspects, the calibration data includes dispense duration curves for a plurality of chemicals, each dispense duration curve representing a relationship between dose duration and a dose volume of a particular chemical.

In another aspect combinable with any of the previous aspects, the calibration data includes a lookup table including dispense durations corresponding to specified amounts of chemicals to be dispensed.

In another aspect combinable with any of the previous aspects, the calibration data includes a chemical viscosity.

In another example implementation, a chemical dispensing system includes an eductor having a diluent inlet, a chemical pickup port, a discharge port, and a venturi fluidly coupled between the diluent inlet and the discharge port; a diluent valve having an outlet coupled to the diluent inlet; a chemical manifold comprising a plurality of chemical inlets and a chemical outlet fluidly coupled to the chemical pickup port; a plurality of chemical valves, each coupled to one of the plurality of chemical inlets; and a controller communicatively coupled to the diluent valve and the plurality of chemical valves and configured to operate the diluent valve and the chemical valves to dispense measured doses of individual chemicals through the chemical pickup port, the controller includes at least one processor and memory storing instructions that, when executed, cause the at least one processor to perform operations including receiving a command to dispense an amount of a particular chemical; accessing dose calibration data corresponding to the particular chemical; determining a dispense duration based on the dose calibration data and the amount; opening a diluent valve coupled to a diluent inlet of an eductor to cause a flow of a diluent through the eductor; opening a chemical inlet valve corresponding to the particular chemical to be dispensed, the chemical inlet valve being fluidly coupled to a chemical pickup port of the eductor; and in response to determining that the dispense duration has elapsed, closing the chemical inlet valve.

In an aspect combinable with the example implementation, the operations include after closing the chemical inlet valve, opening a water flush valve coupled to one of the chemical inlets to flush the chemical inlet manifold.

In another aspect combinable with any of the previous aspects, the operations include measuring a flow rate of the chemical being dispensed using a flow meter fluidly coupled inline between the chemical inlet valve and the chemical pickup port.

In another aspect combinable with any of the previous aspects, the operations include in response to measuring the flow rate, determining that the amount of chemical was dispensed.

In another aspect combinable with any of the previous aspects, the operations include in response to measuring the flow rate, determining that the amount of chemical was not dispensed.

In another aspect combinable with any of the previous aspects, determining that the amount of chemical was not dispensed includes determining that a supply of the chemical fluidly coupled to the chemical inlet valve is low.

In another aspect combinable with any of the previous aspects, the operations include generating an alert indicating that the amount of chemical was not dispensed.

In another example implementation, a process of dispensing chemicals includes receiving a command to dispense an amount of a particular chemical; accessing dose calibration data corresponding to the particular chemical; determining a dispense duration based on the dose calibration data and the amount; opening a diluent valve coupled to a diluent inlet of an eductor to cause a flow of a diluent through the eductor; opening a chemical inlet valve corresponding to the particular chemical to be dispensed, the chemical inlet valve being fluidly coupled to a chemical pickup port of the eductor; in response to determining that the dispense duration has elapsed, closing the chemical inlet valve.

In an aspect combinable with the example implementation, the chemical inlet valve is fluidly coupled to a chemical inlet manifold having a plurality of chemical inlets and a chemical outlet, the chemical outlet being fluidly coupled to the chemical pickup port of the eductor.

Another aspect combinable with any of the previous aspects includes after closing the chemical inlet valve, opening a water flush valve coupled to one of the chemical inlets to flush the chemical inlet manifold.

Another aspect combinable with any of the previous aspects includes measuring a flow rate of the chemical being dispensed using a flow meter fluidly coupled inline between the chemical inlet valve and the chemical pickup port.

Another aspect combinable with any of the previous aspects includes in response to measuring the flow rate, determining that the amount of chemical was dispensed.

Another aspect combinable with any of the previous aspects includes in response to measuring the flow rate, determining that the amount of chemical was not dispensed.

In another aspect combinable with any of the previous aspects, determining that the amount of chemical was not dispensed includes determining that a supply of the chemical fluidly coupled to the chemical inlet valve is low.

Another aspect combinable with any of the previous aspects includes generating an alert indicating that the amount of chemical was not dispensed.

In another example implementation, a process for calibrating a chemical dispensing system includes opening a diluent valve coupled to a diluent inlet of an eductor to cause a flow of a diluent through the eductor; dispensing a chemical by opening a chemical inlet valve fluidly coupled between a chemical reservoir and a chemical pickup port of the eductor; measuring a flow rate of the chemical flowing from the chemical reservoir to the chemical pickup port; determining a time for the measured flow rate to reach a steady state flow rate; and generating a dispense duration curve based on the measured flow rate and the time to reach the steady state flow rate.

In an aspect combinable with the example implementation, measuring the flow rate includes recording a time-series of pulses from a flow meter fluidly coupled inline between the chemical reservoir and the chemical pickup port; and measuring an amount of chemical dispensed.

In another aspect combinable with any of the previous aspects, measuring an amount of chemical dispensed includes determining a weight of chemical dispensed by comparing a weight of the chemical reservoir before dispensing the chemical and a weight of the chemical reservoir after dispensing the chemical.

In another aspect combinable with any of the previous aspects, measuring an amount of chemical dispensed includes recording a time-series of values of weight of the chemical reservoir while dispensing the chemical.

In another aspect combinable with any of the previous aspects, measuring an amount of chemical dispensed includes receiving a first signal indicating a level of the chemical has reached a first sensor of an inline calibration device; receiving a second signal indicating the level of the chemical has reached a second sensor of the inline calibration device; and determining the amount of chemical dispensed based on a known volume of the inline calibration device between the first sensor and the second sensor.

In another aspect combinable with any of the previous aspects, generating a dispense duration curve includes determining an amount of chemical dispensed per pulse based on a total number of recorded pulses and the amount of chemical dispensed; and determining an amount of chemical dispensed as a function of time based on a time-series of pulses and the determined amount of chemical dispensed per pulse.

Another aspect combinable with any of the previous aspects includes generating a lookup table including dispense durations corresponding to specified amounts of chemicals to be dispensed based on the generated dispense duration curve.

In another example implementation, a chemical dispensing system includes a pulsing pump having an inlet and an outlet; a chemical manifold comprising a plurality of chemical inlets and a chemical outlet fluidly coupled to the inlet of the pulsing pump; a plurality of chemical valves having outlets fluidly coupled to the plurality of chemical inlets; a plurality of flow meters having outlets fluidly coupled to inlets of the plurality of chemical valves and inlets of the plurality of hall effect flow meters configured to be fluidly coupled to a plurality of chemical sources; and a controller communicatively coupled to the pulsing pump, the plurality of chemical valves, and the plurality of flow meters.

In an aspect combinable with the example implementation each flow meter includes a housing; an interior chamber disposed within the housing fluidly connecting the inlet of the flow meter and the outlet of the flow meter; a piston disposed within the interior chamber; a spring disposed within the interior chamber between the piston and the outlet of the flow meter, the spring biasing the piston toward the inlet of the flow meter; and a transducer configured to produce an electric signal in response to longitudinal translation of the piston.

In an aspect combinable with the example implementation, the piston includes a magnet and the transducer is a hall effect transducer.

In another aspect combinable with any of the previous aspects, the transducer includes a capacitive detector, an infrared detector, or an ultrasonic detector configured to detect displacement of the piston.

In another aspect combinable with any of the previous aspects, the interior chamber includes a bypass configured to allow fluid to flow from the inlet of the flow meter around the piston through the bypass to the outlet of the flow meter when the piston is longitudinally translated past an opening of the bypass.

In another aspect combinable with any of the previous aspects, a size of the bypass is based on transport properties of the chemical to be dispensed and an expected flow rate of the chemical.

In another aspect combinable with any of the previous aspects, the piston includes a spacer in sliding contact with walls of the interior chamber; and the magnet is disposed within the spacer.

In another aspect combinable with any of the previous aspects, the pulsing pump is a diaphragm pump, a peristaltic pump, a water driven pump, or a piston pump.

In another aspect combinable with any of the previous aspects, the controller includes memory storing calibration data.

In another aspect combinable with any of the previous aspects, the calibration data includes a lookup table including an amount of chemical dispensed per pulse for a plurality of chemicals.

In another aspect combinable with any of the previous aspects, the controller includes at least one processor and memory storing instructions that, when executed, cause the at least one processor to perform operations including receiving a command to dispense an amount of a particular chemical; accessing dose calibration data corresponding to the particular chemical; determining a target number of pulses based on the dose calibration data and the amount; opening a chemical inlet valve corresponding to the particular chemical; operating a pulsing pump to draw the particular chemical from a chemical reservoir through the chemical inlet valve; and in response to determining that the target number of pulses has been reached, closing the chemical inlet valve.

In another example implementations, a process of dispensing chemicals includes receiving a command to dispense an amount of a particular chemical; accessing dose calibration data corresponding to the particular chemical; determining a target number of pulses based on the dose calibration data and the amount; opening a chemical inlet valve corresponding to the particular chemical; operating a pulsing pump to draw the particular chemical from a chemical reservoir through the chemical inlet valve; and in response to determining that the target number of pulses has been reached, closing the chemical inlet valve.

In an aspect combinable with the example implementation, the chemical inlet valve is fluidly coupled to a chemical inlet manifold having a plurality of chemical inlets and a chemical outlet, the chemical outlet being fluidly coupled to an inlet of the pulsing pump.

Another aspect combinable with any of the previous aspects includes after closing the chemical inlet valve, opening a water flush valve coupled to one of the plurality of chemical inlets; and operating the pulsing pump to flush the chemical inlet manifold.

In another aspect combinable with any of the previous aspects, determining that the target number of pulses has been reached includes counting a number of elapsed pulses generated by a flow meter.

In another aspect combinable with any of the previous aspects, generating a pulse by the flow meter includes longitudinally translating a piston disposed within an interior chamber of the flow meter from a first position adjacent to an inlet of the flow meter to a second position that provides access to the opening of a bypass, the piston being translated by movement of fluid through the flow meter; detecting a displacement of the piston by a transducer; and generating, by the transducer, an electrical signal representing the pulse, the pulse indicating that the piston has been translated from the first position to the second position.

Another aspect combinable with any of the previous aspects includes determining a rate of pulses generated by the flow meter.

Another aspect combinable with any of the previous aspects includes determining that the amount of chemical has been dispensed based on the elapsed number of pulses and the rate of pulses.

Another aspect combinable with any of the previous aspects includes determining that the amount of chemical has not been dispensed based on the elapsed number of pulses and the rate of pulses.

In another aspect combinable with any of the previous aspects, determining that the amount of chemical was not dispensed includes determining that a supply of the chemical fluidly coupled to the chemical inlet valve is low.

Another aspect combinable with any of the previous aspects includes generating an alert indicating that the amount of chemical was not dispensed.

In another example implementation, a process for calibrating a chemical dispensing system includes dispensing a chemical from a chemical reservoir fluidly coupled to a chemical inlet valve by opening the chemical inlet valve and operating a pulsing pump fluidly coupled to the chemical inlet valve; recording a time-series of pulses generated by a flow meter fluidly coupled inline between the chemical reservoir and the chemical inlet valve; measuring an amount of chemical dispensed; and determining an amount of chemical dispensed per pulse based on the time-series of pulses and the measured amount of chemical dispensed.

In an aspect combinable with the example implementation, generating a pulse by the flow meter includes longitudinally translating a piston disposed within an interior chamber of the flow meter from a first position adjacent an inlet of the flow meter to a second position that provides access to the opening of a bypass, the piston being translated by movement of fluid through the flow meter; detecting a displacement of the piston by a transducer; and generating, by the transducer, an electrical signal representing the pulse, the pulse indicating that the piston has been translated from the first position to the second position.

In another aspect combinable with any of the previous aspects, measuring an amount of chemical dispensed includes determining a weight of chemical dispensed by comparing a weight of the chemical reservoir before dispensing the chemical and a weight of the chemical reservoir after dispensing the chemical.

In another aspect combinable with any of the previous aspects, measuring an amount of chemical dispensed includes recording a time-series of values of weight of the chemical reservoir while dispensing the chemical.

Another aspect combinable with any of the previous aspects includes generating a lookup table including target numbers of pulses corresponding to amounts of chemicals to be dispensed based on the determined amount of chemical dispensed per pulse.

In another aspect combinable with any of the previous aspects, measuring an amount of chemical dispensed includes receiving a first signal indicating a level of the chemical has reached a first sensor of an inline calibration device; receiving a second signal indicating the level of the chemical has reached a second sensor of the inline calibration device; and determining the amount of chemical dispensed based on a known volume of the inline calibration device between the first sensor and the second sensor.

Particular implementations of the subject matter described in this specification can be implemented to realize one or more of the following advantages. Accurate chemical doses can be dispensed for a wide range of dose volumes and for a wide range of chemical transport properties. For example, chemical doses can be dispensed within 10% of a desired amount over for a range of dose volumes spanning two orders of magnitude. The chemical dispense duration can be tailored to particular chemicals to account for differences in viscosity between chemicals.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for dispensing chemicals.

FIG. 2A is a schematic diagram of the cross-section of an eductor.

FIG. 2B is a schematic diagram of an example inline dosing calibration device.

FIG. 3 is a flow chart of an example process to dispense chemicals using the system of FIG. 1.

FIG. 4 is a flow chart of an example process to calibrate a chemical dispensing system.

FIG. 5 is a block diagram of another example system for dispensing chemicals.

FIGS. 6A-6B are cross-section views of an example hall effect flow meter.

FIG. 7 is a flow chart of an example process for dispensing chemicals using the system of FIG. 5.

FIG. 8 is a flow chart of another example process to calibrate a chemical dispensing system.

FIG. 9 shows a schematic drawing of a control system.

Like reference symbols in the various drawings indicate like elements.

### DETAILED DESCRIPTION

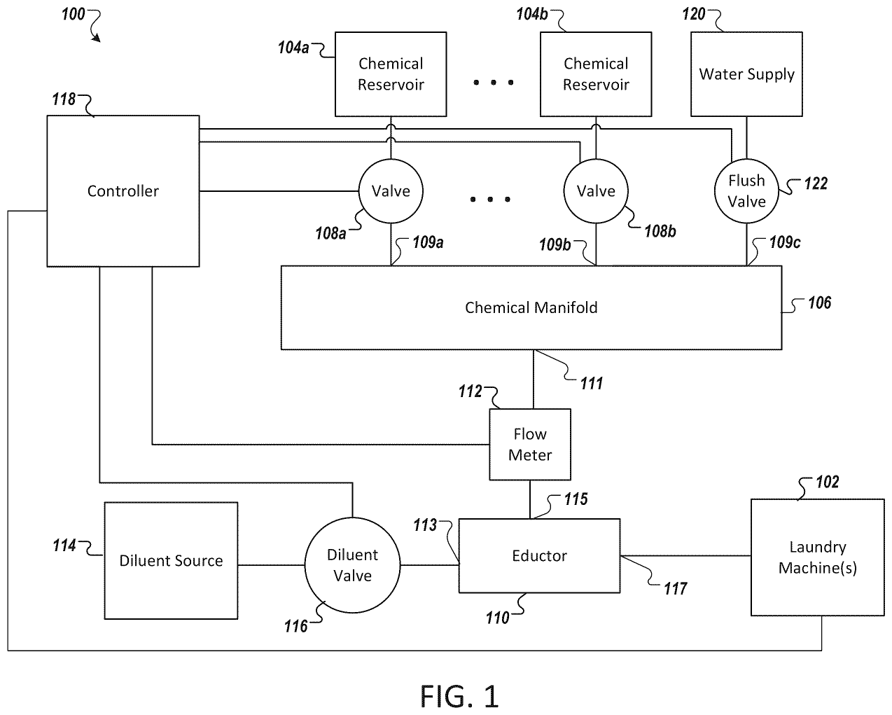

FIG. 1 is a block diagram of an example chemical dispensing system 100. The system 100 includes an eductor 110, multiple chemical reservoirs 104, a chemical manifold 106, and valves 108, 116 that control the flow of chemicals and diluent through the system 100. The system 100 is configured to dispense chemicals into one or more laundry machines 102. Alternatively, or additionally, the system 100 can dispense chemicals into other types of machines or receptacles (e.g., spray bottles, chemical containers, etc.). The system 100 includes multiple chemical reservoirs 104a, 104b (collectively referred to as chemical reservoirs 104) fluidly coupled to a chemical manifold 106. For example, the chemical reservoirs 104 are connected to the chemical manifold 106 directly or indirectly by hosing, tubing, or piping, such that a fluid can flow from the chemical reservoir to the chemical manifold or vice versa. The chemical manifold 106 includes multiple chemical inlets 109a-b and a chemical outlet 111. The chemical outlet 111 is fluidly coupled to the pickup port 115 of a single eductor 110.

A diluent (e.g., water) source 114 is fluidly coupled to the diluent inlet 113 of the eductor 110. A diluent valve 116 controls flow of the diluent from the diluent source 114 through the eductor 110. The diluent valve 116 can be an automated valve, e.g., an electromagnetic valve, a pneumatic valve, or a hydraulic valve. In some cases, the valve 116 can have a manual override. Flow of the diluent through the eductor 110 generates a suction pressure (e.g., a vacuum) at the chemical pickup port 115 to draw chemicals from the chemical manifold 106 through the chemical pickup port 115, mix the chemicals with diluent, and discharge the mixture through the discharge port 117 to the laundry machines 102.

Chemical inlet valves 108a, 108b (collectively referred to as chemical inlet valves 108) are fluidly coupled inline between the associated chemical reservoirs 104 and the chemical manifold 106. A chemical inlet valve 108 is associated with each chemical reservoir 104 in the system 100. Two chemical reservoirs 104 and two chemical inlet valves 108 are shown in FIG. 1; however, the system 100 can include more than two chemical reservoirs 104 and more than two chemical inlet valves (e.g., 3 or more, 5 or more, 10 or more). The chemical inlet valves 108 can be, for example, electromagnetic valves (e.g., solenoid valves), pneumatic valves, or hydraulic valves. In some cases, the chemical inlet valves 108 can have manual overrides. The chemical inlet valves 108 control flow of chemicals from the associated chemical reservoirs 104. The chemical reservoirs 104 can include different chemicals or the same chemical.

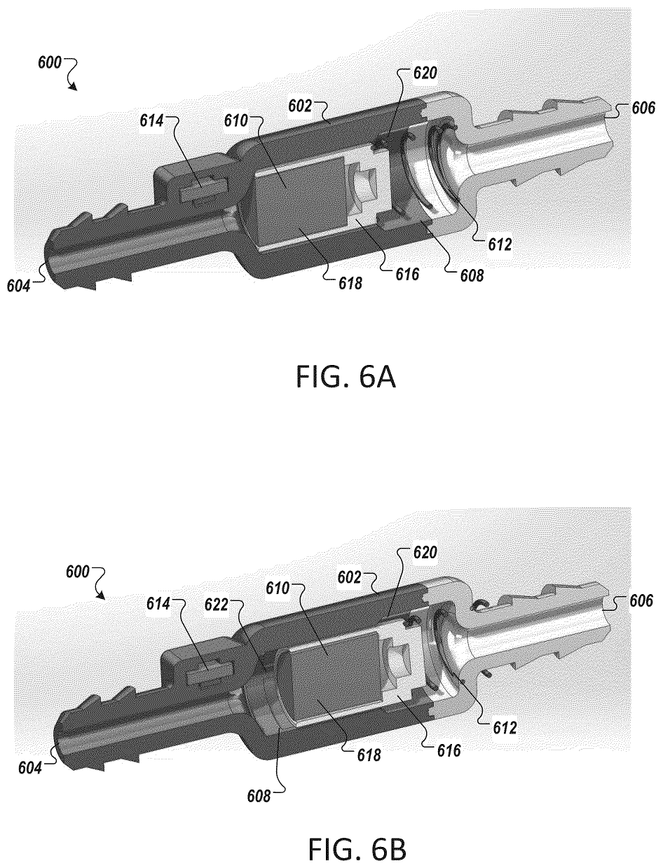

A flow meter 112 is fluidly coupled between the chemical manifold 106 and the pickup port 115 of the eductor 110. The flow meter 112 can be a positive displacement flow meter or a pulsing flow meter (e.g., a hall effect flow meter). The pulsing flow meter is configured to generate electrical pulses that indicate a flow rate of a fluid passing through the flow meter. Operations of a pulsing flowmeter are described in more detail in reference to FIGS. 6A and 6B.

In some implementations, a water supply 120 is fluidly coupled to a chemical inlet 109c of the chemical manifold 106. A water flush valve 122 is coupled between the water supply 120 and the chemical manifold 106 and is configured to control a flow of water to the chemical manifold 106. The water supply 120 can be used, for example, to flush the chemical manifold 106 after dispensing a chemical.

The transport properties of the chemicals (e.g., fluid viscosity) affect the flow rate of the chemical through the system 100. For example, higher viscosities can result in lower flow rates for the same applied pressure differential. Additionally, the layout of the system (e.g., length of tubing and piping) between the chemical reservoirs 104, the eductor 110, and the dispense destination (e.g., laundry machines 102) can affect the flow of the chemical being dispensed. For example, longer tubes cause more frictional pressure losses than shorter tubes thereby reducing the flow rate of the chemical for a given pressure differential.

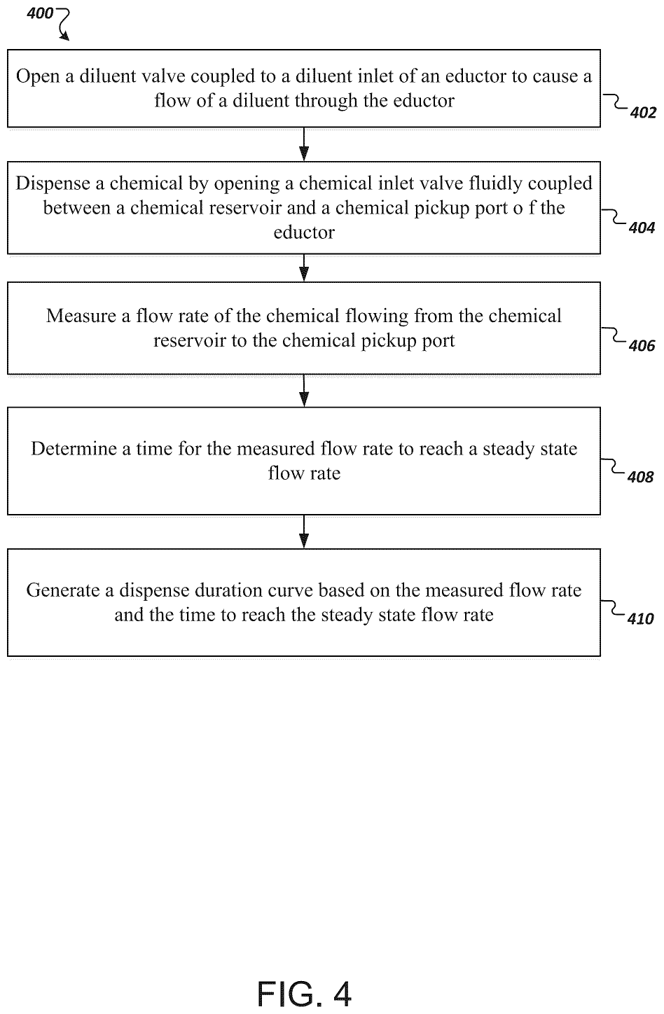

The transport properties of the chemicals and/or the effects of the physical layout of the system can be accounted for by calibrating the system 100 to determine dispense durations required to dispense specified doses (e.g., volumes) of particular chemicals. Calibrations can be done for each chemical that can be used with the system 100, and the calibration data can be stored in a database accessible by the controller 118. An example calibration process will be described in greater detail with reference to FIG. 4.

The controller 118 includes at least one processor and memory storing instructions. The controller 118 is communicatively coupled to the chemical inlet valves 108, the flow meter 112, the diluent valve 116, and the laundry machines 102. The controller 118 can control the diluent valve 116 to control the flow of diluent to the eductor. The controller 118 can control the chemical inlet valves 108 to control the flow of chemicals to the chemical manifold 106. The controller can receive signals from the flow meter 112 to determine a flow rate of chemical from the chemical manifold 106 to the eductor 110.

The controller 118 also stores calibration data. The calibration data can include information about the chemicals to be dispensed such as the chemical name, dosing range, chemical viscosity, etc. In some implementations, the calibration data includes chemical dispense curves for chemicals that can be dispensed by the system 100. Each dispense duration curve can represent a relationship between the dose duration and the dose volume of a particular chemical. In some implementations, the calibration data includes a lookup table including dispense durations corresponding to specified amounts of particular chemicals. The calibration data can be stored, for example, in a database or data store of the controller.

The system 100 can be operated by interfacing the controller 118 with the laundry machines 102. The laundry machines 102 provide signals (e.g., using a communication protocol such as USB, Bluetooth, Wifi, etc.) to request the dispensing of chemicals per a formula per machine. When a qualified signal is detected by the controller 118, the unit can dose the appropriate products routed to the requesting washer according to the settings of the formula and the washing phase being executed.

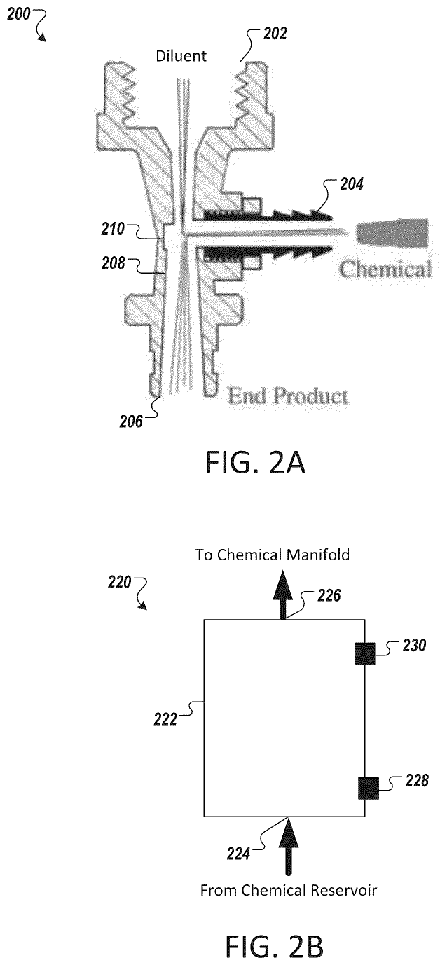

FIG. 2A is a cross-section schematic of an example eductor 200 for use in a chemical dispensing system (e.g., eductor 110). The eductor 200 includes a diluent inlet 202, a chemical pickup port 204, and a discharge port 206. A venturi 208 fluidly couples the diluent inlet 202 and the discharge port 206. The chemical pickup port 204 is located near the throat 210 of the venturi 208. As diluent flows through the venturi 208, the pressure at the throat of the venturi 208 is reduced generating a suction pressure at the chemical pickup port 204. Chemical is drawn into the eductor 200 through the chemical pickup port 204. The chemical mixes with the diluent and discharges through the discharge port 206.

FIG. 2B is a schematic of an example inline dosing calibration device 220. The calibration device 220 includes a housing 222. The housing 222 has an inlet 224 and an outlet 226. The calibration device 220 is configured to be fluidly coupled inline between a chemical reservoir and the chemical manifold. For example, the inlet 224 is configured to be fluidly coupled with a chemical reservoir (e.g., chemical reservoir 104) and the outlet 226 is configured to be fluidly coupled to a chemical manifold (e.g., chemical manifold 106). The calibration device 220 also includes at least two sensors 228 and 230. The sensors 228, 230 are configured to detect a level of fluid in the housing 222. The sensors 228, 230 can be, for example, conductivity sensors, electrical float switches, optical level sensors, ultrasonic level sensors, or hall effect sensors with magnets configured to move based on the level of the fluid. In some implementations, more than two sensors are used to provide additional calibration points. In some implementations, the sensors 228, 230 can be slotted float mechanisms or hall effect devices with multiple magnets that provide additional calibration points.

The calibration device 220 measures a time to dispense a known volume of a chemical. The known volume of chemical is determined by the interior volume of the housing 222 between the sensors 228, 230. For example, in use, a chemical is provided to the inlet 224. When the level of the chemical reaches the first sensor 228, a data processing system (e.g., a controller) starts a timer. When the level of the chemical reaches the second sensor 230, the data processing system records the elapsed time of the timer. Since the volume of the housing 222 between the two sensors 228, 230 is known beforehand, the data processing system determines a calibration for the chemical based on the elapsed time measured.

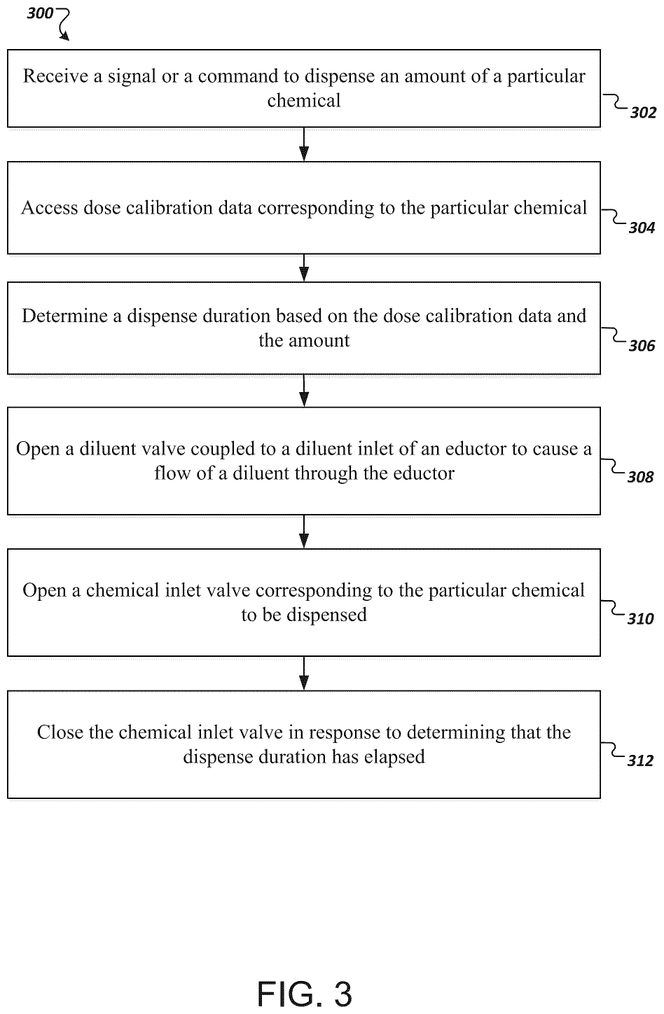

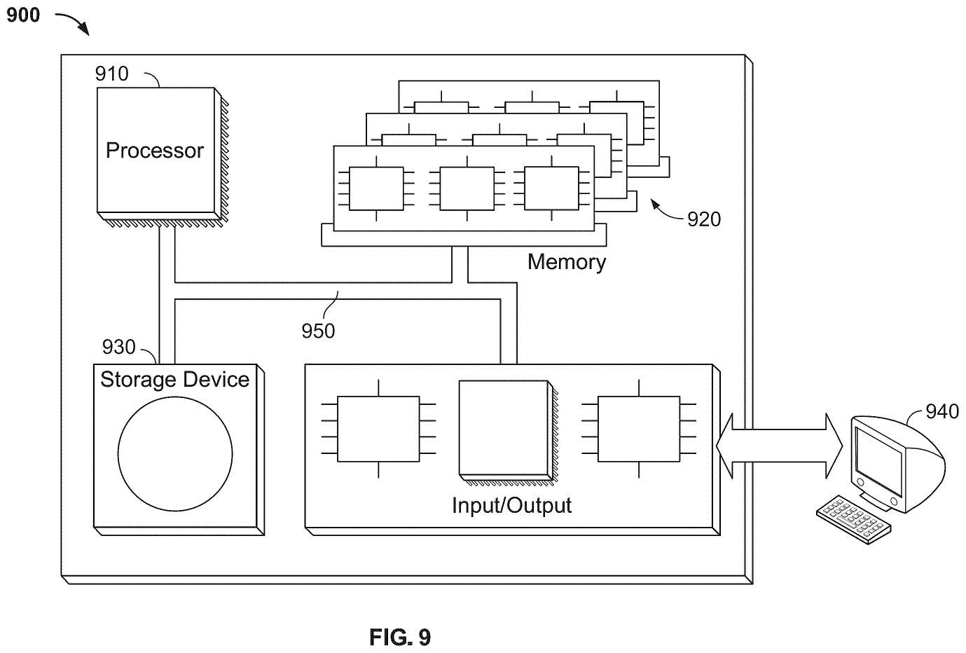

FIG. 3 is a flow chart of an example process 300 of dispensing chemicals using a chemical dispensing system (e.g., system 100). The process 300 is generally described in the context of the other figures in this description. For example, the process 300 can be performed by the controller 118 shown in FIG. 1 or the control system 900 shown in FIG. 9. However, the process 300 may be performed by any suitable system, software, and hardware as appropriate. In some implementations, the process 300 can be run in parallel, in combination, in loops, or in any order.

The controller receives a signal or a command to dispense an amount of a particular chemical (step 302). For example, the controller receives the command to dispense a particular chemical from a laundry machine during a wash cycle. The command can include an identifier for the particular chemical and a volume of the requested dose.

The controller accesses dose calibration data corresponding to the particular chemical (step 304). The dose calibration data can be stored in a memory communicatively coupled to the controller. In some examples, the dose calibration data can be stored in a cloud database accessible to the controller through a network interface. The dose calibration data accounts for the transport properties of the chemicals and the physical layout of the system. The dose calibration data can include information such as dose dispense duration curves that indicate dispense duration as a function of dispense amount for the particular chemical. The dose calibration data can include dose calibration data for multiple chemicals that can be dispensed by the chemical dispensing system. In some implementations, the dose calibration data includes a lookup table with dispense durations for specified dispense amounts.

The controller determines a dispense duration based on the dose calibration data and the amount (step 306). For example, the controller can evaluate the dispense duration curve at the specified amount to determine the dispense duration. In some implementations, the controller looks up the particular chemical and the specified amount in a lookup table. The controller can interpolate (e.g., using linear interpolation or bicubic interpolation) between values in the lookup table if the specified amount falls between volumes specified in the lookup table.

The controller opens a diluent valve coupled to a diluent inlet of an eductor to cause a flow of a diluent through the eductor (step 308). The flow of diluent through the eductor generates a suction pressure at the chemical pickup port of the eductor.

The controller opens a chemical inlet valve corresponding to the particular chemical to be dispensed, the chemical inlet valve being fluidly coupled to a chemical pickup port of the eductor (step 310). The chemical inlet valve is fluidly coupled to a chemical inlet manifold having multiple chemical inlets and a chemical outlet. The chemical outlet is fluidly coupled to the chemical pickup port of the eductor. The suction pressure generated by the flow of diluent through the eductor, draws the particular chemical from the chemical reservoir through the open chemical inlet valve into the chemical manifold and into the chemical pickup port of the eductor. The chemical mixes with the diluent in the eductor and is dispensed through the discharge port of the eductor. In some implementations, the controller opens the chemical inlet valve after the flow of diluent through the eductor reaches a steady state flow rate. For example, the controller can open the chemical inlet valve at a specified time after the controller opens the diluent valve (e.g., 0.1 seconds or more, 0.5 seconds or more, 1 second or more). Alternatively, or additionally, the controller opens the chemical inlet valve based on a pressure or flow rate of the diluent.

The controller can determine that the dispense duration has elapsed and in response, close the chemical inlet valve (step 312). For example, the controller can initialize a dispense timer when the chemical inlet valve is opened. The controller determines that the dispense duration has elapsed when the dispense timer reaches the determined dispense duration.

After closing the chemical inlet valve, the controller can open a water flush valve coupled to one of the chemical inlets to flush the chemical inlet manifold. For example, the controller opens the water flush valve allowing water from a water supply to flow into the chemical manifold and into the chemical pickup port of the eductor to flush out chemical remaining from the dispense operation. In some implementations, the controller can flush the chemical manifold prior to a dispense operation.

In some implementations, the controller measures a flow rate of the chemical being dispensed using a flow meter fluidly coupled inline between the chemical inlet valve and the chemical pickup port. The flow meter (e.g., flow meter 112) can be a positive displacement flow meter or a hall effect flow meter. In response to measuring the flow rate, the controller can determine that the specified amount of chemical was dispensed. For example, the controller can compare the measured flow rate with an expected flow rate based on the accessed dose calibration data and when the measured and expected flow rates match within a defined tolerance, the controller can determine that the amount of chemical was dispensed.

In some implementations, in response to measuring the flow rate, the controller can determine that the specified amount of chemical was not dispensed. For example, if the measured flow rate does not match the expected flow rate within the defined tolerance, then the controller can determine that the specified amount of chemical was not dispensed. In response to determining that the specified amount of chemical was not dispensed, the controller can generate an alert (e.g., an audible alarm and/or a visual indicator such as a flashing icon or light) indicating that that the specified amount of chemical was not dispensed.

In some implementations, the controller can determine that the level of chemical in the chemical reservoir for the chemical being dispensed is low (e.g., the chemical reservoir is out of product). For example, if the measured flow rate is much higher than the expected flow rate, this can indicate that air is being drawn into the system instead of the particular chemical. coupled to the chemical inlet valve is low. In response, the controller can generate an alert indicating that the chemical level is low. If a second chemical reservoir including the same chemical is fluidly coupled to a different chemical inlet of the chemical manifold (e.g., two or more chemical reservoirs of the same chemical are fluidly coupled to the system), the controller can dispense the specified amount of the particular chemical from the second chemical reservoir.

In some implementations, the controller can determine the status of various operations of the chemical dispensing system and generate alerts when the controller determines that a condition is not met satisfactorily. For example, the controller can perform a leak test by opening the diluent valve of the eductor while maintaining the water flush and chemical inlet valves in a closed position. If the controller measures a flow rate using the flow meter, then the controller can determine that there is a leak in the chemical manifold and/or the attachments to the chemical manifold.

In some implementations, the controller can perform a water test and/or a flush test by opening the diluent valve of the eductor to allow flow of diluent through the eductor and opening the water flush valve coupled to the chemical manifold. The controller can measure the flow rate of water through the flow meter, and if the measured flow rate deviates from an expected flow rate beyond a threshold deviation, the controller can determine that there is an issue with the water flush operation.

FIG. 4 is an example process 400 for calibrating a chemical dispensing system. The process 400 is generally described in the context of the other figures in this description. For example, the process 400 can be performed by the controller 118 shown in FIG. 1 or the control system 900 shown in FIG. 9. However, the process 400 may be performed by any suitable system, software, and hardware as appropriate. In some implementations, the process 400 can be run in parallel, in combination, in loops, or in any order.

The controller opens a diluent valve coupled to a diluent inlet of an eductor to cause a flow of a diluent through the eductor (step 402). The flow of diluent through the eductor generates a suction pressure at the chemical pickup port of the eductor.

The controller dispenses a chemical by opening a chemical inlet valve fluidly coupled between a chemical reservoir and a chemical pickup port of the eductor (step 404).

The controller measures a flow rate of the chemical flowing from the chemical reservoir to the chemical pickup port (step 406). Measuring the flow rate can include recording a time-series of pulses from a pulsing flow meter (e.g., a hall effect flow meter) or a positive displacement flow meter fluidly coupled inline between the chemical reservoir and the chemical pickup port; and measuring an amount of chemical dispensed. For example, measuring an amount of chemical dispensed can include determining a weight of chemical dispensed by comparing a weight of the chemical reservoir before dispensing the chemical and a weight of the chemical reservoir after dispensing the chemical. The weight of the chemical reservoir can be measured using, for example, a scale or a load cell. The weight of the chemical dispensed can be converted to volume using the density of the chemical. In some implementations, the load cell is communicatively coupled to the controller providing, for example, closed loop feedback of the chemical dispensing. In some implementations, the controller records a time-series of values of weight of the chemical reservoir while dispensing the chemical. Measuring a time-series of values can include the controller closing the chemical inlet valve at one or more times while dispensing the chemical to measure the weight of the chemical reservoir and recording the values of the weight at each time.

In some implementations, the controller measures the flow rate based on signals received from an inline calibration device (e.g., calibration device 220). For example, the controller receives a signal from the inline calibration device indicating that a level of the chemical has reached a first level sensor. In response, the controller starts a timer. The controller receives a second signal from the inline calibration device indicating that the level of the chemical has reached a second level sensor. In response, the controller records the time elapsed on the timer. Based on a known volume of the inline calibration device and the elapsed time, the controller determines the flow rate of the chemical.

The controller determines a time for the measured flow rate to reach a steady state flow rate (step 408). For example, the controller can determine that the flow rate has reached a steady state flow rate by determining that the magnitude of the rate of change of the flow rate has fallen below a specified threshold. The continuous flow of chemical generated by the eductor allows the chemical flow to reach a steady state thereby increasing the accuracy of the flow rate measurement using a positive displacement flow meter as compared to an intermittent or pulsing flow.

The controller generates a dispense duration curve based on the measured flow rate and the time to reach the steady state flow rate (step 410). For example, the controller can generate a dispense duration curve by determining an amount of chemical dispensed per pulse based on a total number of recorded pulses and the amount of chemical dispensed. The chemical dispensed per pulse can be, for example, a time averaged value after the flow rate reaches steady state. The chemical dispensed per pulse can be a time-dependent value that captures the transient startup of the flow of chemical before the flow rate reaches a steady state. For example, the controller can determine an amount of chemical dispensed as a function of time based on the time-series of pulses and the determined chemical dispensed per pulse. The controller can generate the dispense duration curve by finding a best curve fit to the measured flow rate and measured amount of chemical dispensed data. A calibration based on multiple data points can be more accurate over a dosing range than a calibration based on a single data point. In some implementations, the controller determines a viscosity value of the chemical based on the best curve fit.

In some implementations, the controller can generate a lookup table that includes dispense durations corresponding to specified amounts of chemicals to be dispensed based on the generated dispense duration curve. In some implementations, the controller generates the lookup table based on the recorded flow rate and the amount of chemical dispensed data.

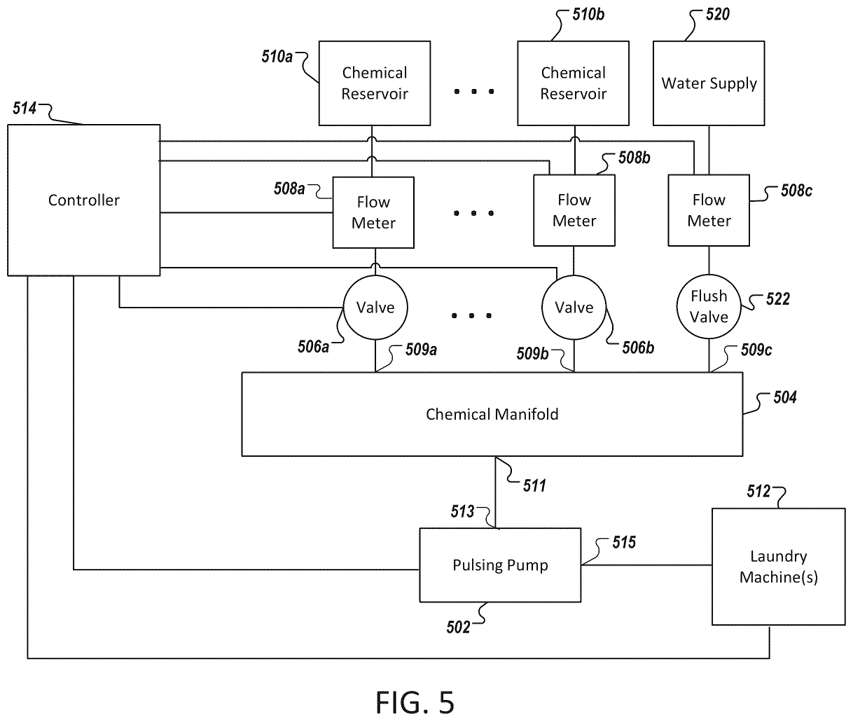

FIG. 5 is another example chemical dispensing system 500. The system 500 includes a pulsing pump 502 (e.g., a diaphragm pump, a peristaltic pump, a piston pump, or other pump that delivers fluid in a non-continuous flow) that draws chemicals from a chemical manifold 504. The chemical manifold includes multiple chemical inlets 509a-c. Chemical inlet valves 506a, 506b and linear displacement hall effect flow meter 508a, 508b are fluidly coupled inline between respective chemical inlets 509a, 509b of the chemical manifold 504 and chemical reservoirs 510a, 510b. A chemical outlet 511 is fluidly coupled to an inlet 513 of the pulsing pump 502. The pulsing pump 502 dispenses chemicals from the chemical manifold 504 to laundry machines 512 through the outlet 515 of the pulsing pump 502.

In some implementations, a water supply 520 is fluidly coupled to a chemical inlet 509c of the chemical manifold 504. A water flush valve 522 is fluidly coupled between the water supply 520 and the chemical manifold 504 and is configured to control a flow of water to the chemical manifold 504. The water supply 520 can be used, for example, to flush the chemical manifold 506 after dispensing a chemical.

The system 500 includes a controller 514 that is communicatively coupled to the pulsing pump 502, the chemical inlet valves 506, the flow meters 508, and the laundry machines 512. The controller 514 can receive commands from the laundry machines to dispense chemicals. The controller can control the pulsing pump 502 and the valves 506 to dispense measured doses of requested chemicals based on measurements from the flow meter. The controller 514 includes dose calibration data indicating a dispense duration and/or a target number of pulses required to dispense a specified amount of chemical.

FIGS. 6A-6B show cross-sections of a linear displacement hall effect flow meter 600. The flow meter 600 includes a housing 602 having an inlet 604 and an outlet 606. The housing 602 includes an interior chamber 608. A magnetic piston 610 is disposed inside the interior chamber 608. A spring 612 is disposed within the interior chamber 608 between the magnetic piston 610 and the outlet 606. The spring 612 biases the magnetic piston 610 toward the inlet 604.

The flow meter 600 also includes a transducer 614. The transducer 614 can measure the magnetic field of the magnetic piston 610. The transducer 614 generates an electrical signal in response to longitudinal displacement of the magnetic piston 610 (e.g., displacement of the magnetic piston in the direction from the inlet to the outlet or vice versa).

The magnetic piston 610 can include a spacer 616 in sliding contact with the interior walls of the interior chamber 608. A magnet 618 can be disposed inside the spacer. The magnet be resistant to corrosion by chemicals for which the flow meter is used to measure flow rates. Alternatively, or additionally, the magnet 618 can be encapsulated in the spacer 616, and the spacer 616 provides protection from the chemicals to the magnet 618.

The flow meter 600 includes a bypass 620 in the interior chamber 608. The bypass 620 allows fluid to flow around the magnetic piston 610 when the magnetic piston 610 is displaced beyond the opening of the bypass 620.

In a first position (shown in FIG. 6A), the magnetic piston 610 blocks flow through the flow meter. When a flow starts, pressure builds and acts on the magnetic piston 610 to move the magnetic piston 610 to a second position (shown in FIG. 6B). In the second position, the opening 622 of the bypass 620 is exposed to the fluid, and the fluid can flow around the magnetic piston 610. The transducer 614 generates an electronic signal indicating that the magnetic piston 610 has been displaced. When the flow stops, the spring 612 pushes the magnetic piston 610 back to the first position blocking the opening to the bypass.

When the flow meter 600 is used in combination with a pulsing pump (e.g., pulsing pump 502), the flow meter 600 generates an electronic pulse for each pulse of the pump. Chemical dispensing systems can be calibrated to determine a number of pulses required to dispense a particular amount of a particular chemical. By counting the pulses generated by the flow meter 600, a controller can determine that the target number of pulses has been reached independently of pump characteristics (e.g., pump volume, average number of pump pulses per minute or per second, etc.).

The flow meter 600 can be made from materials compatible with the application. For example, a material can be selected based on chemically compatibility, cost effectiveness, process effectiveness, robustness, or expected service life. The flow meter 600 can be manufactured through methods such as injection molding which can reduce the cost of the flow meter 600 such that it is not cost prohibitive to have a flow meter attached to each chemical inlet of a chemical dispensing system (e.g., system 500).

In some implementations, the transducer is a capacitive detector, an infrared detector, an ultrasonic detector, or other detector that can detect a displacement of the piston 610. In such implementations, the piston 610 can be non-magnetic.

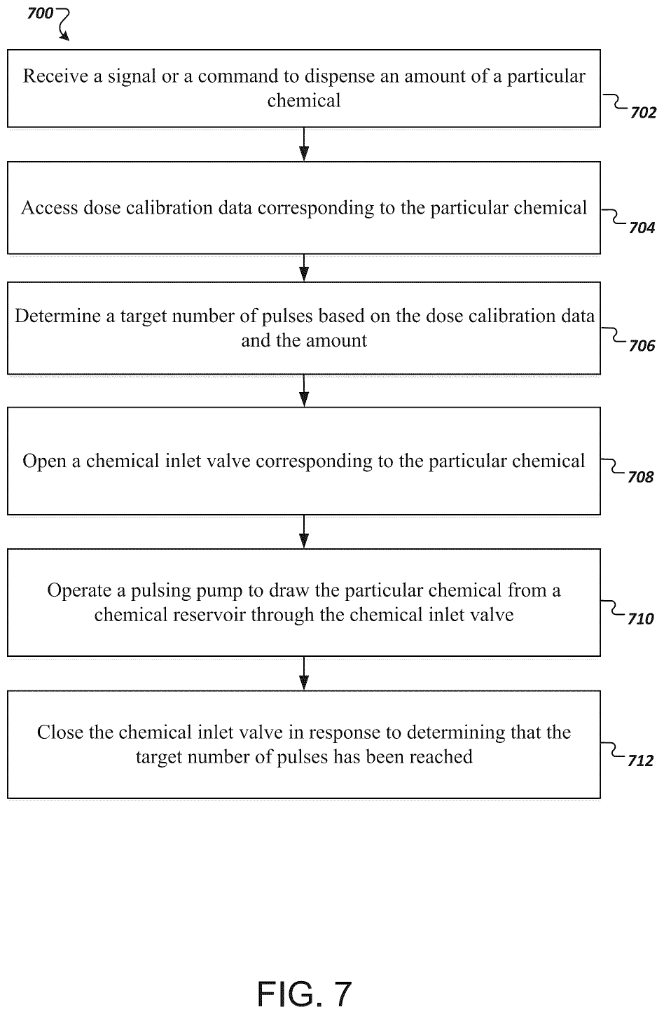

FIG. 7 is a flow chart of another example process 700 for dispensing chemicals using a chemical dispensing system (e.g., system 500). The process 700 is generally described in the context of the other figures in this description. For example, the process 700 can be performed by the controller 514 shown in FIG. 5 or the control system 900 shown in FIG. 9. However, the process 700 may be performed by any suitable system, software, and hardware as appropriate. In some implementations, the process 700 can be run in parallel, in combination, in loops, or in any order.

The controller receives a command to dispense an amount of a particular chemical (step 702). For example, the controller receives the command to dispense a particular chemical from a laundry machine during a wash cycle. The command can include an identifier for the particular chemical and a volume of the requested dose.

The controller accesses dose calibration data corresponding to the particular chemical (step 704). The dose calibration data can be stored in a memory communicatively coupled to the controller. The dose calibration data accounts for the transport properties of the chemicals and the physical layout of the system. The dose calibration data can include information such as chemical viscosity, number of pulses of a flow meter per volume, and number of pulses of a flow meter per time. The dose calibration data can include dose calibration data for multiple chemicals that can be dispensed by the chemical dispensing system. In some implementations, the dose calibration data includes a lookup table with target numbers of pulses for specified dispense amounts.

The controller determines a target number of pulses of a flow meter based on the dose calibration data and the amount (step 706). For example, the controller can determine the target number of pulses based on a number of pulses per volume dispensed. In some implementations, the controller looks up the particular chemical and the specified amount in a lookup table. The controller can interpolate (e.g., using linear interpolation or bicubic interpolation) between values in the lookup table if the specified amount falls between volumes specified in the lookup table.

The controller opens a chemical inlet valve corresponding to the particular chemical to be dispensed, the chemical inlet valve being fluidly coupled to a pulsing pump (step 708). The chemical inlet valve is fluidly coupled to a chemical inlet manifold having multiple chemical inlets and a chemical outlet. The chemical outlet is fluidly coupled to the pulsing pump.

The controller operates the pulsing pump to draw the particular chemical from a chemical reservoir through the chemical inlet valve (step 710).

The controller closes the chemical inlet valve in response to determining that the target number of pulses has been reached (step 712). For example, the controller can determine that the target number of pulses has been reached by counting the number of pulses generated by a flow meter (e.g., flow meter 600). The flow meter can generate pulses by longitudinally translating a piston disposed within an interior chamber of the flow meter from a first position adjacent an inlet of the flow meter to a second position that provides access to the opening of a bypass, the piston being translated by movement of fluid through the flow meter. A transducer of the flow meter detects a displacement of the piston (e.g., by measuring a magnetic field or capacitance), and the transducer generates an electrical signal representing the pulse. The pulse indicates that the piston has been translated from the first position to the second position.

After closing the chemical inlet valve, the controller can open a water flush valve coupled to one of the chemical inlets and operate the pulsing pump to flush the chemical inlet manifold. For example, the controller opens the water flush valve allowing water from a water supply to flow into the chemical manifold and into the pulsing pump. In some implementations, the controller can flush the chemical manifold prior to a dispense operation.

In some implementations, the controller determines a rate of pulses generated by the flow meter. The controller can determine that the amount of chemical has been dispensed based on the elapsed number of pulses and the rate of pulses. For example, the controller can compare the elapsed number of pulses and the determined rate of pulses to an expected rate of pulses, and if the determined rate and the expected rate match within an allowable error, the controller can determine that the amount of chemical has been dispensed. In some implementations, the controller can compare an elapsed dispense duration with an expected dispense duration to determine that the amount of chemical has been dispensed.

The controller can determine that the amount of chemical has not been dispensed based on the elapsed number of pulses and the rate of pulses. For example, the controller can compare the elapsed number of pulses and the determined rate of pulses to and expected number of pulses and an expected rate of pulses. If the elapsed number of pulses or the determined rate of pulses deviates from the expected values outside of an allowable error, the controller can determine that the amount of chemical was not dispensed.

In some implementations, the controller determines that the chemical reservoir is low on chemical when the rate of pulses is higher than the expected rate of pulses. For example, air drawn into the pulsing pump can cause the flow meter to pulse at a higher rate than the expected rate indicating that the chemical reservoir is running out of chemical.

In some implementations, the controller generates an alert indicating that that the specified amount of chemical was not dispensed. The alert can be an audible alert (e.g., a constant or repeating tone or series of tones) and/or a visual alert (e.g., a flashing light, an icon on a display).

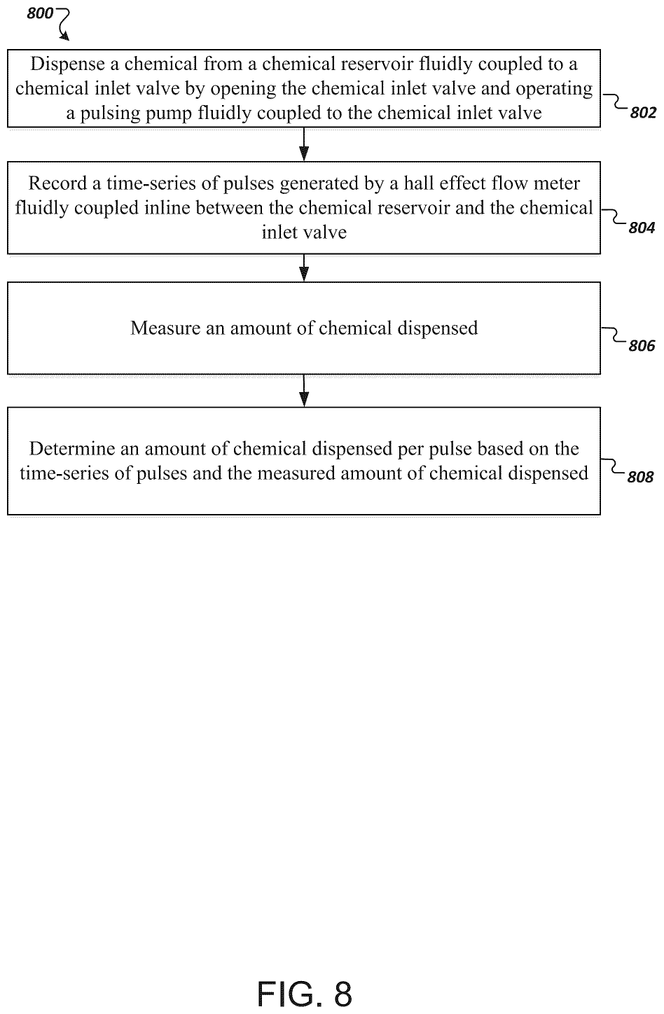

FIG. 8 is an example process 800 for calibrating a chemical dispensing system (e.g., system 500). The process 800 is generally described in the context of the other figures in this description. For example, the process 800 can be performed by the controller 514 shown in FIG. 1 or the control system 900 shown in FIG. 9. However, the process 800 may be performed by any suitable system, software, and hardware as appropriate. In some implementations, the process 800 can be run in parallel, in combination, in loops, or in any order.

The controller dispenses a chemical from a chemical reservoir fluidly coupled to a chemical inlet valve by opening the chemical inlet valve and operating a pulsing pump fluidly coupled to the chemical inlet valve (step 802). The pulsing pump draws the chemical from the chemical reservoir into the inlet of the pulsing pump through a chemical manifold.

The controller records a time-series of pulses generated by a flow meter (e.g., flow meter 600) fluidly coupled inline between the chemical reservoir and the chemical inlet valve (step 804). The time-series of pulses represent the flow rate of the chemical flowing from the chemical reservoir to the pulsing pump. The flow meter can generate pulses by longitudinally translating a piston disposed within an interior chamber of the flow meter from a first position adjacent an inlet of the flow meter to a second position that provides access to the opening of a bypass, the magnetic piston being translated by movement of fluid through the flow meter. A transducer of the flow meter measures a displacement of the piston, and the transducer generates an electrical signal representing the pulse. The pulse indicates that the piston has been translated from the first position to the second position.

The controller measures an amount of chemical dispensed (step 806). For example, measuring an amount of chemical dispensed can include determining a weight of chemical dispensed by comparing a weight of the chemical reservoir before dispensing the chemical and a weight of the chemical reservoir after dispensing the chemical. The weight of the chemical reservoir can be measured using, for example, a scale or a load cell. The weight of the chemical dispensed can be converted to a volume using the density of the chemical. In some implementations, the controller records a time-series of values of weight of the chemical reservoir while dispensing the chemical. Measuring a time-series of values can include the controller closing the chemical inlet valve at one or more times while dispensing the chemical to measure the weight of the chemical reservoir and recording the values of the weight at each time.

In some implementations, the controller measures the amount of chemical dispensed based on signals received from an inline calibration device (e.g., calibration device 220). For example, the controller receives a signal from the inline calibration device indicating that a level of the chemical has reached a first level sensor. In response, the controller starts a timer. The controller receives a second signal from the inline calibration device indicating that the level of the chemical has reached a second level sensor. In response, the controller records the time elapsed on the timer. Based on a known volume of the inline calibration device and the elapsed time, the controller determines a flow rate of the chemical.

The controller determines an amount of chemical dispensed per pulse based on the time-series of pulses and the measured amount of chemical dispensed (step 808). The chemical dispensed per pulse can be, for example, a time averaged value including the total number of the pulses measured over the dispense duration divided by the amount of chemical dispensed.

In some implementations, the controller can generate a lookup table that includes target numbers of pulses corresponding to specified amounts of chemicals to be dispensed based on the determined amount of chemical dispensed per pulse. In some implementations, the controller generates the lookup table based on the recorded flow rate and the amount of chemical dispensed data.

FIG. 9 shows a schematic drawing of a control system 900 that can be used in the example chemical dispensing systems of FIGS. 1 and 5 according to the present disclosure. For example, all or parts of the control system (or controller) 900 can be used for the operations described previously, for example as or as part of the controller 118 or 514. The control system 900 is intended to include various forms of digital processing systems such as computers programmable logic controllers (PLC), printed circuit boards (PCB), processors, digital circuitry, or otherwise. Additionally, the system can include portable storage media, such as, Universal Serial Bus (USB) flash drives. For example, the USB flash drives can store operating systems and other applications. The USB flash drives can include input/output components, such as a wireless transmitter or USB connector that can be inserted into a USB port of another computing device.

The control system 900 includes a processor 910, a memory 920, a storage device 930, and an input/output device 940. Each of the components 910, 920, 930, and 940 are interconnected using a system bus 950. The processor 910 is capable of processing instructions for execution within the control system 900. The processor can be designed using any of a number of architectures. For example, the processor 910 can be a CISC (Complex Instruction Set Computers) processor, a RISC (Reduced Instruction Set Computer) processor, or a MISC (Minimal Instruction Set Computer) processor.

In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the control system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the control system 900. In one implementation, the storage device 930 is a computer-readable medium. In various different implementations, the storage device 930 can be a floppy disk device, a hard disk device, an optical disk device, a tape device, flash memory, a solid state device (SSD), or a combination thereof.

The input/output device 940 provides input/output operations for the controller 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, e.g., both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including e.g., semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, cellular networks, and the Internet.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications can be made without departing from the spirit and scope of the disclosure. For example, example operations, methods, or processes described herein can include more steps or fewer steps than those described. Further, the steps in such example operations, methods, or processes can be performed in different successions than that described or illustrated in the figures. Accordingly, other implementations are within the scope of the following claims.

1. A chemical dispensing system comprising:
an eductor having a diluent inlet, a chemical pickup port, a discharge port, and a venturi fluidly coupled between the diluent inlet and the discharge port;
a diluent valve having an outlet coupled to the diluent inlet;
a chemical manifold comprising a plurality of chemical inlets and a chemical outlet fluidly coupled to the chemical pickup port;
a plurality of chemical valves, each coupled to one of the plurality of chemical inlets; and
a controller communicatively coupled to the diluent valve and the plurality of chemical valves and configured to operate the diluent valve and the chemical valves to dispense measured doses of individual chemicals through the chemical pickup port.

2. The system of claim 1, further comprising: a flow meter fluidly coupled inline between the outlet of the chemical manifold and the chemical pickup port.

3. The system of claim 2, wherein the flow meter comprises a piston, and the flow meter is configured to measure a flow rate based on displacement of the piston.

4. The system of claim 3, wherein the flow meter comprises a capacitive detector, an infrared detector, an ultrasonic detector, or a hall effect detector configured to detect displacement of the piston.

5. The system of claim 1, wherein the discharge port is fluidly coupled to one or more laundry machines.

6. The system of claim 1, wherein an inlet of at least one of the chemical valves is fluidly coupled to a chemical reservoir.

7. The system of claim 1, wherein the controller comprises memory storing calibration data.

8. The system of claim 6, wherein the calibration data comprises dispense duration curves for a plurality of chemicals, each dispense duration curve representing a relationship between dose duration and a dose volume of a particular chemical.

9. The system of claim 6, wherein the calibration data comprises a lookup table comprising dispense durations corresponding to specified amounts of chemicals to be dispensed.

10. The system of claim 6, wherein the calibration data comprises a chemical viscosity.

11-19. (canceled)

20. A process for calibrating a chemical dispensing system, the process comprising:
opening a diluent valve coupled to a diluent inlet of an eductor to cause a flow of a diluent through the eductor;
dispensing a chemical by opening a chemical inlet valve fluidly coupled between a chemical reservoir and a chemical pickup port of the eductor;
measuring a flow rate of the chemical flowing from the chemical reservoir to the chemical pickup port;
determining a time for the measured flow rate to reach a steady state flow rate; and
generating a dispense duration curve based on the measured flow rate and the time to reach the steady state flow rate.

21. The process of claim 20, wherein measuring the flow rate comprises:
recording a time-series of pulses from a flow meter fluidly coupled inline between the chemical reservoir and the chemical pickup port; and
measuring an amount of chemical dispensed.

22. The process of claim 21, wherein measuring an amount of chemical dispensed comprises determining a weight of chemical dispensed by comparing a weight of the chemical reservoir before dispensing the chemical and a weight of the chemical reservoir after dispensing the chemical.

23. The process of claim 21, wherein measuring an amount of chemical dispensed comprises recording a time-series of values of weight of the chemical reservoir while dispensing the chemical.

24. The process of claim 21, wherein measuring an amount of chemical dispensed comprises:
receiving a first signal indicating a level of the chemical has reached a first sensor of an inline calibration device;
receiving a second signal indicating the level of the chemical has reached a second sensor of the inline calibration device; and
determining the amount of chemical dispensed based on a known volume of the inline calibration device between the first sensor and the second sensor.

25. The process of claim 20, wherein generating a dispense duration curve comprises:
determining an amount of chemical dispensed per pulse based on a total number of recorded pulses and the amount of chemical dispensed; and
determining an amount of chemical dispensed as a function of time based on a time-series of pulses and the determined amount of chemical dispensed per pulse.

26. The process of claim 20, further comprising: generating a lookup table comprising dispense durations corresponding to specified amounts of chemicals to be dispensed based on the generated dispense duration curve.

27. A chemical dispensing system comprising:
a pulsing pump having an inlet and an outlet;
a chemical manifold comprising a plurality of chemical inlets and a chemical outlet fluidly coupled to the inlet of the pulsing pump;
a plurality of chemical valves having outlets fluidly coupled to the plurality of chemical inlets;
a plurality of flow meters having outlets fluidly coupled to inlets of the plurality of chemical valves and inlets of the plurality of hall effect flow meters configured to be fluidly coupled to a plurality of chemical sources; and
a controller communicatively coupled to the pulsing pump, the plurality of chemical valves, and the plurality of flow meters.

28. The system of claim 27, wherein each flow meter comprises:
a housing;
an interior chamber disposed within the housing fluidly connecting the inlet of the flow meter and the outlet of the flow meter;
a piston disposed within the interior chamber;
a spring disposed within the interior chamber between the piston and the outlet of the flow meter, the spring biasing the piston toward the inlet of the flow meter; and
a transducer configured to produce an electric signal in response to longitudinal translation of the piston.

29. The system of claim 28, wherein the piston comprises a magnet and the transducer is a hall effect transducer.

30-53. (canceled)
